(19) United States
(12) Patent Application Publication
(10) Pub. No.: US 2024/0037609 A1
(43) Pub. Date: Feb. 1, 2024

(54) SYSTEM AND METHOD FOR ENHANCING PROPERTY INSPECTION AND APPRAISAL

(71) Applicant: Lissa Elizabeth Brutus, Wilmington, DE (US)

(72) Inventor: Lissa Elizabeth Brutus, Wilmington, DE (US)

(21) Appl. No.: 17/815,610

(22) Filed: Jul. 28, 2022

(51) Int. Cl. G06Q 30/02; G06Q 50/16

(52) U.S. Cl. CPC G06Q 30/0278; G06Q 50/163

(57) ABSTRACT

A device runs an app that permits more speedy and less cumbersome data entry and data collection during a property inspection or appraisal. Displays are provided to allow data entry for property characteristics, as well as notes, audio and photos, all within a single app. Provision is made for synchronizing real time entered and collected data with a cloud-based account, permitting highly efficient inspection or appraisal report generation.

### FIELD OF THE INVENTION

The present invention relates to the use of one mobile device application (app) to complete the inspection and appraisal of commercial properties, with or without internet service.

### BACKGROUND

The present invention relates to systems and methods for facilitating inspection and appraisal of properties, and more particularly commercial properties.

Presently in the art, a property inspector would need to alternate between taking notes in a “notes app” (usually on a personal phone used for business purposes), open another app for voice recordings, carry a paper checklist on a clipboard and a camera (or cell phone), all while doing their best to take notes that can explain which picture is which. As a result, report generation is often cumbersome, and requires assembly of information from multiple distinct sources after conclusion of an appraisal inspection. Furthermore, the appraisal industry continues to age. Technological advances are needed to both advance the industry and attract the younger population to the industry overall.

As can be seen, there is a need for an improved system and method for facilitating property report generation by property appraisers/inspectors.

### BRIEF SUMMARY OF THE INVENTION

The present invention allows for all the user's needs while on property inspections, particularly commercial property inspections, to be met by one app instead of toggling between multiple apps. Thus it improves currently computerized technology by improving the functioning of the computer. Currently, the larger or more complex a property is, the more difficult it can be to keep track of different notes, and to differentiate between photos of units that look similar. By indexing and cross referencing on the fly in real time, in a single app, a property inspector and appraiser can complete the needed tasks much more quickly and in a manner less prone to error.

The app of the present invention also allows for all data to be stored on a web-based cloud system, that keeps the user's business and personal information separate. It also aids in keeping property information together in one easy to access place.

In one app, the user can use the following:
Notes—instead of the notes app that includes other personal information, all notes can be associated with the appropriate job and stored on a web-based cloud system.
Checklist—this eliminates the need for a clipboard, one less potential for hazard, and allows for consistency from project to project as well as in-office between team members.
Photos—property inspection photos will no longer take up space in personal phone memory, and photos are automatically stored on a web-based cloud system.
Audio—record the inspection from beginning to end or stop the recording in segments, and audio files are automatically stored on a web-based cloud system.

The system and method of the present invention therefore allows a far more efficient way to collect data while gathering relevant property information, before, during and after the property inspection, by eliminating the need for multiple apps to run at the same time.

### BRIEF DESCRIPTION OF THE DRAWINGS

FIG. 1 is a flow chart of aspects of the present invention, from opening the application through presentation of a property menu.

FIG. 2 is a flow chart of aspects of the present invention, including the select property feature of the property menu, including alternate selectability of submenus for audio, photos, checklist and notes.

FIG. 3 is a flow chart of aspects of the present invention, including details concerning the audio menu.

FIG. 4 is a flow chart of aspects of the present invention, including details concerning the photos menu.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. While an app will be herein described runnable on a smartphone or a tablet, it will be apparent to one of ordinary skill in the art that the same concepts and operations may be performed using a laptop or desktop computer.

The main utility of the app is its ability for a user to toggle among four basic submenus in any order during an inspection: “Notes”, “Checklist”, “Photos” and “Audio.” The “Notes” feature includes some basic editing options that allows for the user to stay as organized as possible. Some of the options include:
Bold/Italic/Underline/Strikethrough.
Font/Font Size/Bullets.
Attaching Link/Photo/Film/etc.

Upon completion of the inspection, or during any relevant sync command, the notes information is synchronized and uploaded to the web-based cloud system.

The “Checklist” feature can be customized to accommodate different user preferences. This feature provides the user's office with a consistent format that every user can follow. At the bottom of the prepopulated checklist, the user also has the option to include any additional rooms while completing the list. Upon completion of the inspection, the notes information is synchronized and uploaded to the web-based cloud system.

The “Photo” feature allows for photos to be taken and stored to a cloud. Once a photo is taken, a preview of the photo pops up with the option to “retake” or “use photo.” After an option is chosen, the camera resets to take the next picture until the user chooses “cancel.” Once cancel is chosen, the user can then view thumbnails of each picture and has the option to “upload to the cloud,” “edit picture name” or “delete.”

The “Audio” feature allows the user to record the inspection in the background while toggling between the other features. Each recording can be “uploaded to the cloud,” “labeled” or “deleted.”

If the internet is not available at the time of entry, the information is briefly stored on the user's phone under the app. Upon internet availability, the information is transferred from the app to the cloud system and removed from the phone's memory. Because all the features are included on one app, there is less battery drain on user's phone's as well. This is an important feature when inspecting properties with a large number of units in one day.

The app saves the user time on the front and back ends of use. Prior to the inspection, available property information can be entered and be verified on-site. After the inspection is completed, because all the information is cloud based, the user can access all their notes, checklist information, photos, and recordings without having to spend time deleting them from a phone afterwards. Users can also eliminate the need to connect their personal phones to a computer in order to download photos, helping to prevent personal photos and information from potentially ending up on a work server.

All of the subject property's information can be accessed on the user's computer webpage, at a centralized account stored on a cloud server. Upon log in, the user can download all files to the office server, and delete the property from the web-based cloud system. This feature is highly useful due to the sensitive nature of property information in the commercial real estate industry, especially in the instance of real estate appraiser where the entire business is based on property information and access to it.

It will be noted that the sync option in embodiments described below generally syncs the entire set of records associated with a particular user account when it occurs. However, it is within the spirit of the invention to configure the device to partially sync only those aspects of a particular property, and a particular record related to that property, on a partial or ad hoc basis.

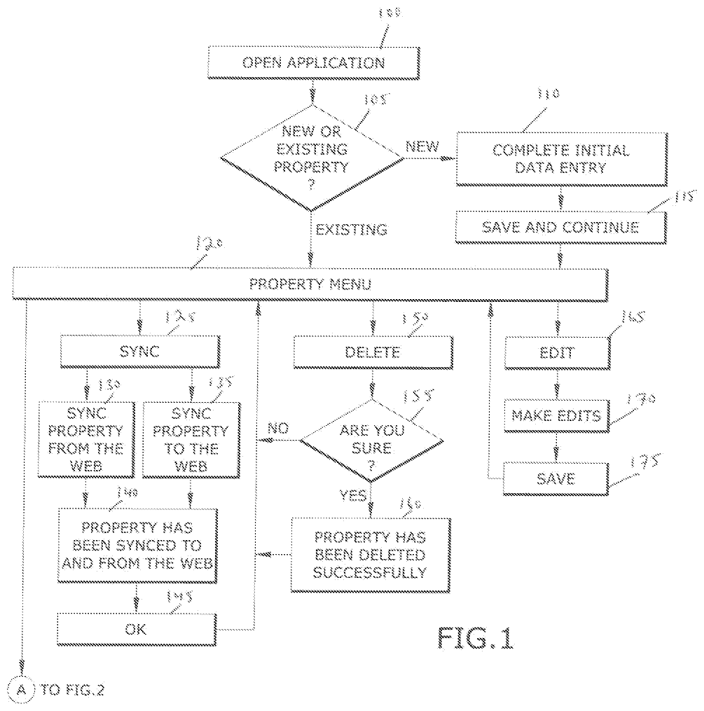

FIGS. 1-4 provide flowchart examples of steps that may be taken by software within an app to practice the disclosed invention. While the following description mentions screens, features so described may be combined severally onto one screen, or features described as occurring with respect to one screen may be divided among multiple screens without departing from the spirit of the present invention.

Regarding FIG. 1, at step 100, a user opens the app in the conventional way (e.g., touching an icon on a smartphone touchscreen). In a first screen thereafter, the app provides a user choice 105 whether to work on a new or existing property. If new, the user at step 110 completes initial data entry (e.g., job number, property title, property type, property address, city, state and zip, tax ID, inspection date and inspection time) and executes save and continue operation 115. If existing, or after the foregoing save and continue 115 operation, the app presents property menu 120 on a next screen. This menu 120 identifies selectable properties (either new or previously configured). An option (not shown) is included to retrieve from a cloud server a list of previously configured properties that may be operated on from this screen. Upon selection of the property of interest, the app provides the option to sync 125, delete 150 or edit 165.

Sync 125 option provides a choice either to sync property information from a cloud or web based server account 130, or sync the property to a cloud or web based server account 135. Message 140 thereafter indicates on screen that the property has been synced to or from the web, as the case may be. Option 145 now appears to acknowledge “ok,” and thereby go back to property menu 120 and select the property of interest as has been hereindescribed.

Delete 150 option provides for instruction to delete, with confirmation choice 155 being presented by the app to ask “are you sure” to the user. If “no” is chosen, the app will thereby go back to property menu 120 and allow selection of the property of interest as has been hereindescribed. If “yes” is chosen, message 160 will appear on screen indicating successful deletion, and the app will thereby go back to property menu 120 and allow selection of the property of interest as has been hereindescribed.

Edit 165 option presents a screen to make edits 170, to adjust any aspect of the initial data entry, where thereafter the app permits such edits to be saved 175.

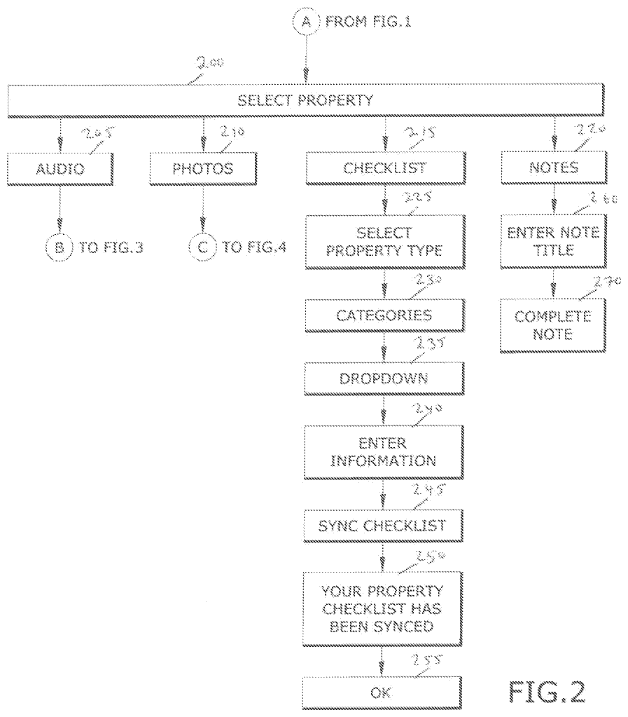

Regarding FIG. 2, upon selection of the property of interest, the app also allows select property menu 200 to appear on a next screen. This menu permits selection of audio option 205, photos option 210, checklist 215 and notes 220, in an asynchronous order according to the sequencing chosen by the user.

Checklist 215 option allows data entry for a number of property features that the inspector/appraiser will encounter and that are standard for reports in the industry. For example, these may include, as indexed to the job number, the property type 225 and the property categories 230 (such as history, exterior, parking lot, roof, security, number of units, hallway/entryway, etc.). Each property category may cause display on screen of a questionnaire dropdown 235 (for example, property history may include year built, year renovated, land area, acres, land area sqft, land shape, lot type, lot direction, etc.), allowing information entry 240 in each case. Checklist 215 also permits, at any time and as many times as the user likes, the syncing of the checklist 245 to the cloud/web during the data entry process, along with success message 250 when that is done. After completion of checklist 215 option, the user may then select ok 255, and the app will thereby go back to property menu 120 and allow selection of the property of interest as has been hereindescribed.

Notes 220 option allows text of any variety to be associated with the specific property record. The app permits entry of the note title 260, and a user's indication that the note is complete 270.

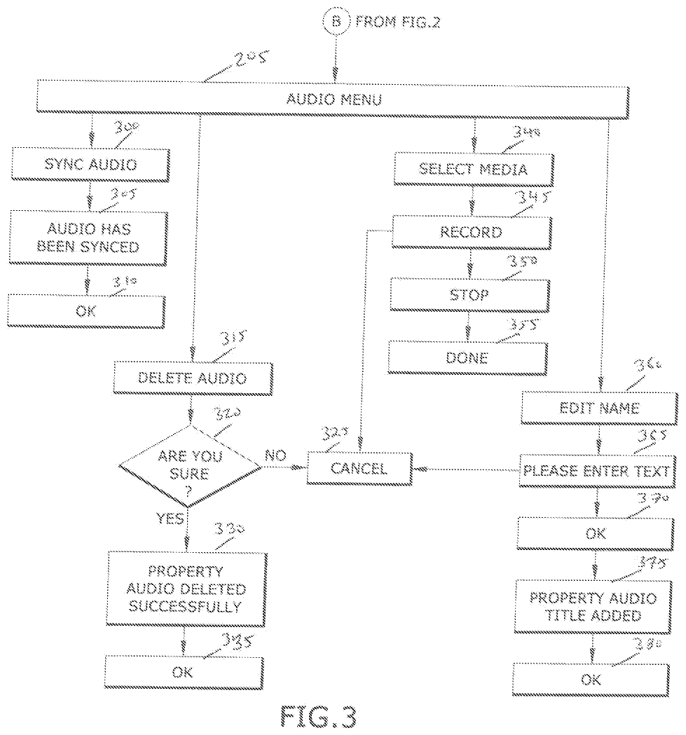

Regarding FIG. 3, audio option 205 permits select media 340 option, permitting user indications to record 345, stop recording 350, and indication 355 that the user has finished and therefore the app will go back to the main audio menu for audio option 205. This main audio menu includes providing a user option to edit the name 360 used to label the audio recording, subsequent entry of text 365 (e.g. “Bedroom 1”), completion of that text entry 370, followed by a confirmation message that the property audio title has been added 375, and an “ok” user indication 380 to go back to the main audio menu.

It should be noted that the app allows cancellation 325 of either the record 345 option or the text entry 365 option, during those processes, to cancel and delete undesired data.

Audio option 205 also permits deletion of audio 315 after it has been recorded and not canceled. Such an operation will lead to a confirmation query 320, which can either result in cancel 325, or if “yes,” confirmation 330 that the audio was deleted, followed by the “ok” choice 335 to go back to the main audio menu.

Finally, audio option 205 permits a sync audio 300 option to save audio to the cloud or web account. A confirmation message 305 indicates successful audio syncing, followed by the “ok” choice 310 to go back to the main audio menu.

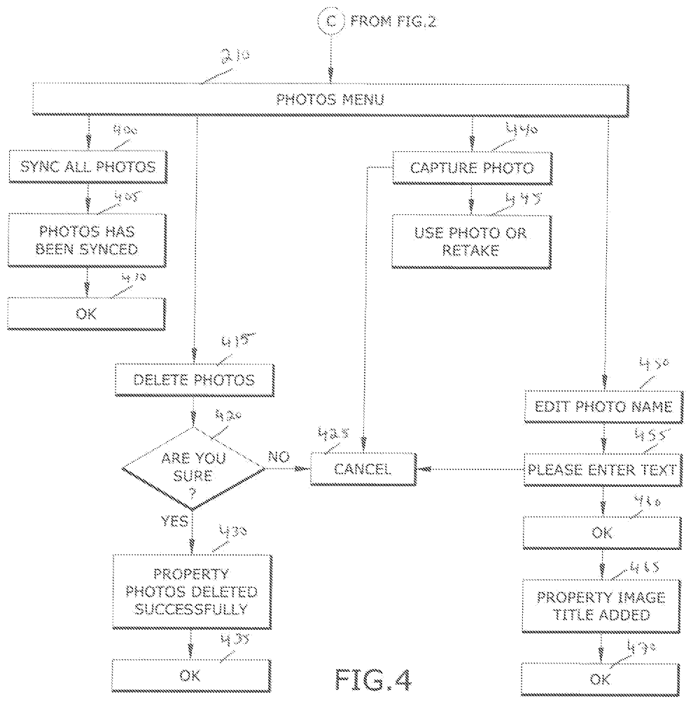

Regarding FIG. 4, photo option 210 operates in a similar fashion to audio option 205. It permits user capture of a photo 440 with display of the photo to the user, with cancellation option 425, and after storing with a photo thumbnail associated with such a photo record, with an option 445 for the user to use the photo or retake it. This photo menu 210 includes providing a user option to edit the name 450 used to label the photo, subsequent entry of text 455 (e.g. “Bedroom 1” or “Bath 1”), completion of that text entry 460, followed by a confirmation message that the property photo has been added 465, and an “ok” user indication 470 to go back to the main audio menu. As mentioned before, a screen may present an option for a user to take multiple photos (or retake them) before entering a cancel command to exit photo option 210.

Photo option 210 also permits deletion of photos 415 after it has been recorded. Such an operation will lead to a confirmation query 420, which can either result in cancel 425, or if “yes,” confirmation 430 that the audio was deleted, followed by the “ok” choice 435 to go back to the main audio menu.

Finally, photo option 210 permits a sync all photos 400 option to save photos to the cloud or web account. A confirmation message 405 indicates successful photo syncing, followed by the “ok” choice 410 to go back to the main photo menu. At the main photo menu 210, a list of named photos with thumbnails may be provided, each with an independent option to sync, edit the name, or delete.

After the app has allowed completing audio option 205 or photo option 210 to the user's satisfaction, the app allows return to the property menu 120 as hereindescribed with respect to FIG. 1.

It will be appreciated that the embodiments described herein permit in-the-field efficient collection of property inspection and appraisal information (and related data entry) all in a single app. It improves preexisting computer technology to result in a more advanced computer technology. The syncing of data so-collected may then advantageously populate a database or spreadsheet record in a cloud-based restricted access account. That database record for a single or multiple property inspections may then advantageously populate a standard inspection and appraisal report form, either while still in the cloud or after being downloaded to an office server.

The system of the present invention may include at least one computer with a user interface. The computer may include any computer including, but not limited to, a desktop, laptop, and smart device, such as, a tablet and smart phone (iPhone or Android style). The computer includes a program product including a machine-readable program code for causing, when executed, the computer to perform steps, including the various user interfaces described herein. The program product may include software which may either be loaded onto the computer or accessed by the computer. The loaded software may include an application on a smart device. The software may be accessed by the computer using a native app (described above). The computer may download the software via a native app download utility, or via the web browser using the internet, extranet, intranet, host server, internet cloud, computer app, web app, phone app and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It is well understood that a processor and memory are included in the device. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

I claim:

1. An apparatus for facilitating creation of property inspection reports, comprising:
a device executing computer program code to host a property inspection data entry and data gathering application, the device having at least one processor and at least one memory;
computer program code executing on the device providing instructions to generate on a display a first user interface configured to receive a first user input for defining a property ID;
computer program code executing on the device providing instructions to generate on a display a user interface configured to receive a second user input for defining property characteristics associated with the property ID;
computer program code executing on the device providing instructions to generate on a display a user interface configured to receive a third user input for providing notes associated with the property ID;
computer program code executing on the device providing instructions to generate on a display a user interface configured to receive a fourth user input for providing audio associated with the property ID; and
computer program code executing on the device providing instructions to generate on a display a user interface configured to receive a fifth user input for providing at least one photo associated with the property ID.

2. The apparatus of claim 1, further comprising:
computer program code executing on the device providing instructions to generate on a display a user interface configured to receive a sixth user input for synchronizing the first through fifth user inputs with a record stored on an account accessible through a network.

3. The apparatus of claim 1, wherein the second user input comprises one or more of property type, property age and property size.

4. The apparatus of claim 1, wherein the fourth user input comprises a text name for an item of recorded audio.

5. The apparatus of claim 1, wherein the fifth user input comprises a name for a photograph.

6. The apparatus of claim 4, further comprising computer program code executing on the device providing instructions to receive an audio deletion command.

7. The apparatus of claim 5, further comprising computer program code executing on the device providing instructions to receive a photo deletion command.

8. The apparatus of claim 2, comprising computer program code executing on the device providing instructions to generate on a display a user interface configured to synchronize to the account from the device.

9. The apparatus of claim 2, comprising computer program code executing on the device providing instructions to generate on a display a user interface configured to synchronize from the account to the device.

10. The apparatus of claim 1, comprising computer program code executing on the device providing instructions to generate on a display data gathered in response to the fifth user input, in the form of either a full photo or a thumbnail of a photo.
